(19) United States
(12) Patent Application Publication
(10) Pub. No.: US 2011/0110627 A1
(43) Pub. Date: May 12, 2011

(54) BEAM COLLIMATOR

(75) Inventor: Chang Ching TSAI, Orlando, FL (US)

(73) Assignee: Dr. Chang Ching TSAI, Orlando, FL (US)

(21) Appl. No.: 12/910,832

(22) Filed: Oct. 24, 2010

Related U.S. Application Data
(60) Provisional application No. 61/259,154, filed on Nov. 7, 2009.

(51) Int. Cl. G02B 27/30; G02B 6/26; G02B 6/32; G02B 6/34

(52) U.S. Cl. 385/33; 385/43; 385/37

(57) ABSTRACT

A device, method of collimating beam coming out from an optical tapered-core guided wave structure with change of index of refraction longitudinally along the axial direction of the tapered-core guided wave structure in the core or cladding region is proposed in this invention. The guided wave structure includes optical fibers and waveguides. The beam collimator in this invention is combined with light couplers and illuminating sources in applications to laser surgery, machinery, probing, measuring, weapons, imaging devices.

### CROSS REFERENCE TO RELATED APPLICATIONS

The present application claims priority to U.S. Provisional Application No. 61/259,154, which is hereby incorporated by reference in its entirety.

### BACKGROUND

The description relates to beam collimators.

In some examples, lights or lasers emitting from optical fibers diverge in free space due to diffraction. Non-divergent, collimated beam is often used in laser cutting, soldering, drilling, laser surgery, optical probing and measurement etc. A lens system is commonly used to collimate the diffracted light from an optical fiber. A bulky lens assembly, however, limited the application to micro domains.

In a paper published by Chang-Ching Tsai et al., Optics Express, Vol. 17, Issue 24, pp. 21723-21731 (2009), suggested a particular structure of a slab waveguide to produce a thin-diffractionless light sheet in free space without employment of collimating lens system. The light sheet is used as plane-illumination for optical projection tomography. This particular slab waveguide requires specific slowly changes of both refractive index and core configuration in a two-dimensional structure.

In the present invention, a three-dimensional structure of optical fiber featuring tapered fiber core and longitudinal graded-index is proposed. This fiber can directly generate collimated beam by the designed configuration without other optical elements attached.

### SUMMARY

In a primary object, the present invention is to provide an apparatus, method for collimating beam out from an optical fiber.

In a second object, the present invention is to provide a fiber beam collimator for use in application together with an illuminating light source and other optical elements.

These and other objects are met by the invention as enclosed in the present patent claims.

In one embodiment, a fiber collimator includes an optical fiber with a tapered structure in the core region, a variable index of refraction nₐ in the cladding, and a variable index of refraction n_{c} in the core regions, respectively.

In one embodiment, the longitudinal direction z is the direction of light propagation along the axis of an optical fiber, in which the variable indexes of refraction nₐ(z) or n_{c}(z) are graded-index functions of z.

In one embodiment, the fiber collimator is designed by slowly changing the value of nₐ(z) longitudinally to approach a constant value of nₐ in the facet of the fiber terminated in the air.

In one embodiment, the fiber collimator is designed by slowly changing the value of n_{c}(z) longitudinally to approach a constant value of nₐ in the facet of the fiber terminated in the air.

In one embodiment, the fiber collimator is designed by slowly changing the values of nₐ(z) and n_{c}(z) longitudinally to approach an intermediate constant value of n_{b} in the facet of the fiber terminated in the air.

Advantage of the present fiber collimator is to collimate beam by diminishing the difference of nₐ(z) and n_{c}(z) in the fiber end terminated in the air without any lens attached. The size of the collimated beam is very small, about the same order of the fiber core. Further objects and advantages of this invention will be apparent from the following detailed description with accompanied drawings.

### DESCRIPTION OF DRAWINGS

FIG. 1 is the facet of an optical fiber.

FIG. 2 is a tapered-core fiber with longitudinal graded index of refraction in the core.

FIG. 3 is a tapered-core fiber with longitudinal graded index of refraction in the cladding.

FIG. 4 is a tapered-core fiber with longitudinal graded index of refraction in the core and cladding.

FIG. 5 are graphs.

FIG. 6 are examples of n_{c}(z) approaching nₐ or nₐ(z) approaching n_{c}. along the axial z direction of the fiber linearly.

FIG. 7 are examples of n_{c}(z) approaching nₐ or nₐ(z) approaching n, along the axial z direction of the fiber nonlinearly.

FIG. 8 are examples of n_{c}(z) approaching nₐ or nₐ(z) approaching n, along the axial z direction of the fiber discontinuously with stepwise structure.

FIG. 9 are examples of an elliptical fiber and a rectangular waveguide that can be used as a beam collimator in this invention.

### DETAILED DESCRIPTION

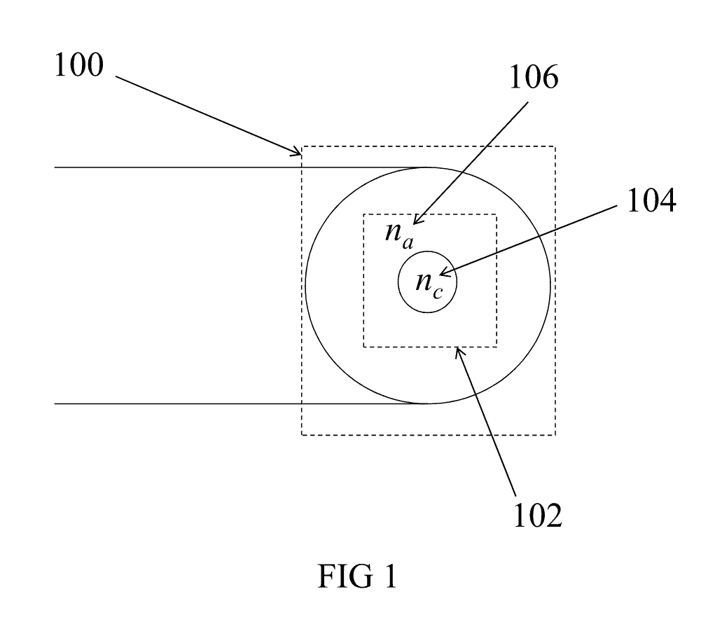

FIG. 1 shows an ordinary optical fiber facet 100 with a phase aperture 102 formed by the core refractive index n_{c} 104 surrounded by the cladding refractive index nₐ 106. From optical Kirchhoff diffraction theory, the phase aperture 102 is the cause of diffraction. If n_{c} 102≈nₐ 104, then the phase aperture 102 diminishes, a non-diffracted, collimated, beam would be expected.

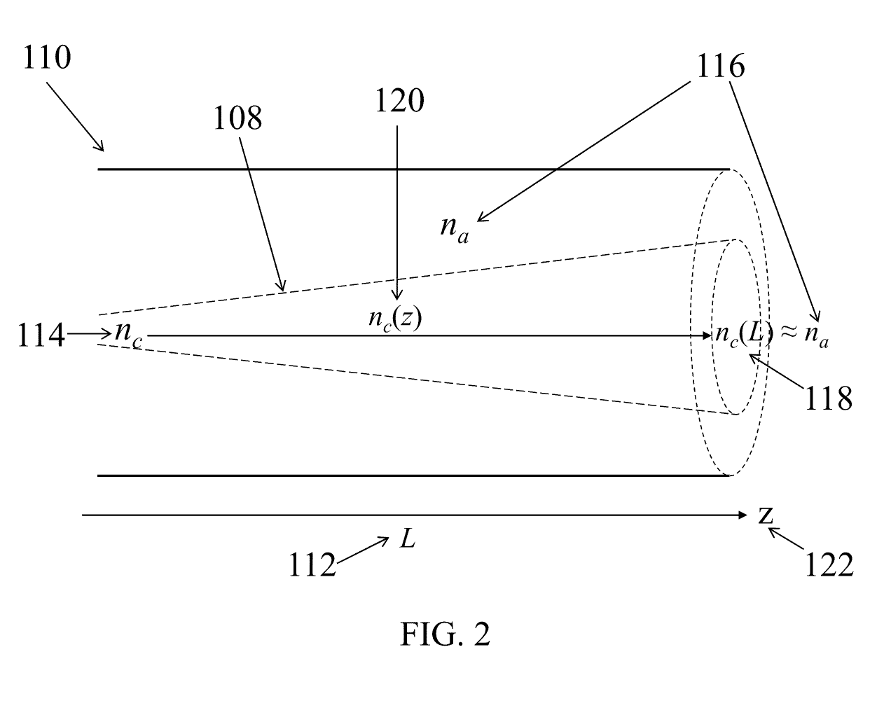

To support an optical mode that light can propagate inside the fiber requires the condition n_{c} 102≈nₐ 104. For lunching light into an optical fiber, the coupling loss is inversely proportional to the fiber numerical aperture NA (NA=[n_{c}²−nₐ²]^{0.5}). In order to reach the diminish of the phase aperture 102, setting n_{c} 102≈nₐ 104, an extremely small NA ([n_{c}²−nₐ²]^{0.5}->0) will occur in the present invention. Therefore, the coupling loss would be very large. To overcome this issue, in one example, FIG. 2 shows a tapered-core 108 fiber structure 110 of length L 112 with a larger NA (n_{c} 114>nₐ 116) at the input end and a small NA (n_{c}(L) 118≈nₐ 116) at the output end. In such a tapered core 108 structure with n_{c}(z) 120 gradually approaching nₐ 116 along the axial z 122 direction, i.e. n_{c}(L) 118->nₐ 116, an ordinary diffracted optical mode can smoothly, due to the tapered core 108 transition, transfer into a collimated mode at the end of the fiber 110.

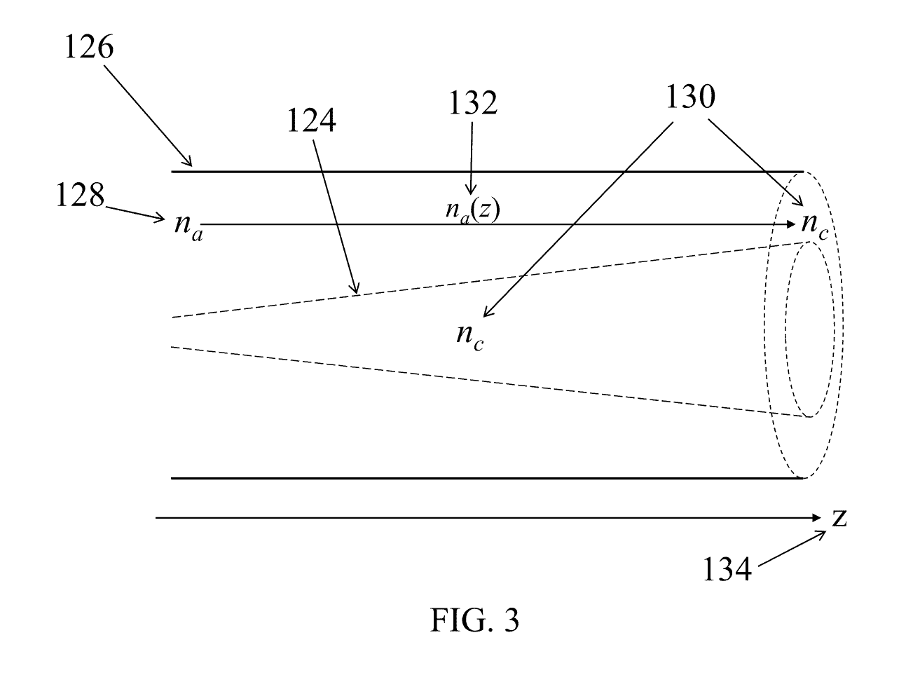

In another example, FIG. 3 shows an alternate way of diminishing the phase aperture 102. At the input end of a tapered-core 124 fiber 126, with nₐ 128 gradually approaching nₐ 130 by a function nₐ(z) 132 along the axial z 134 direction of the fiber 126.

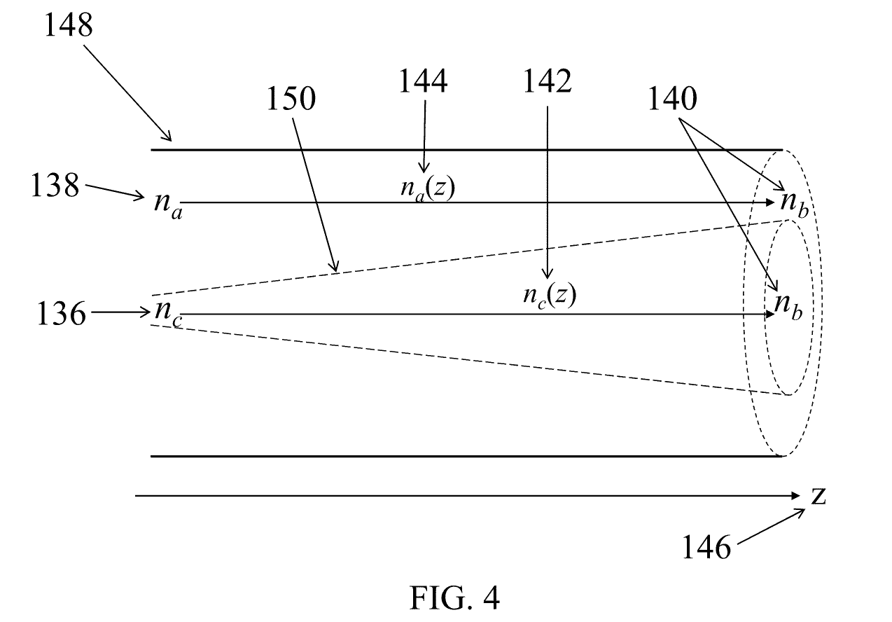

In another example, FIG. 4 shows an alternate way of diminishing the phase aperture 102, both nₐ 136 and nₐ 138 gradually approaching an intermediate constant value n_{b} 140 by functions of n_{c}(z) 142 and nₐ(z) 144 along the axial z 146 direction of a fiber 148 with a structure of tapered core 150.

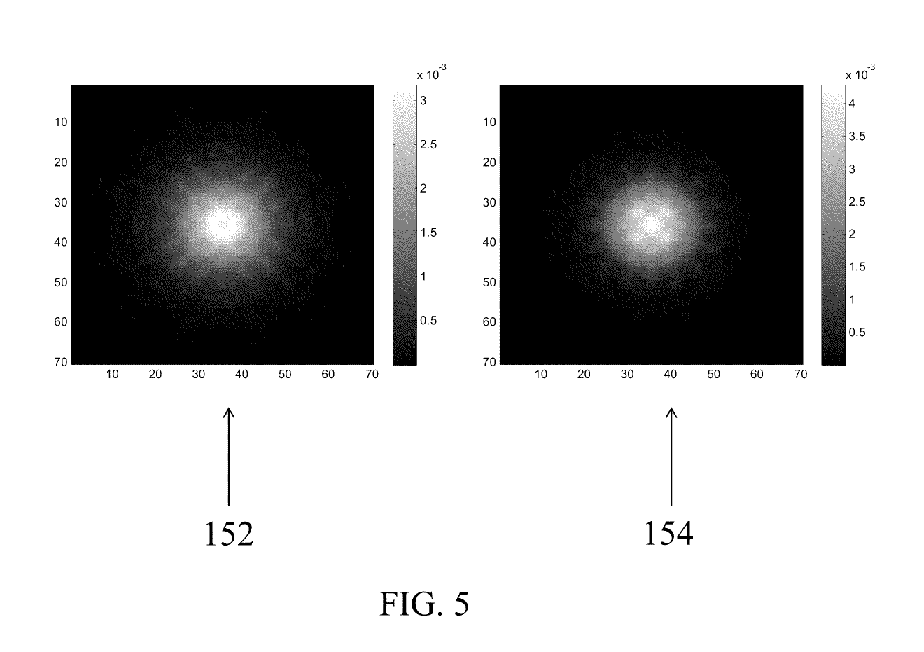

FIG. 5 shows the numerical result of a 532 nm laser coming out of an optical fiber 126 with the configuration described in the example, FIG. 3. The collimated beam 152 is drawn after 500 micron propagation in the air from the terminated end of fiber 126. Beam 154 is drawn at the terminated end of fiber 126 before emitting. Beam 152 keeps approximately the beam size of beam 154, which gives a good demonstration of collimation.

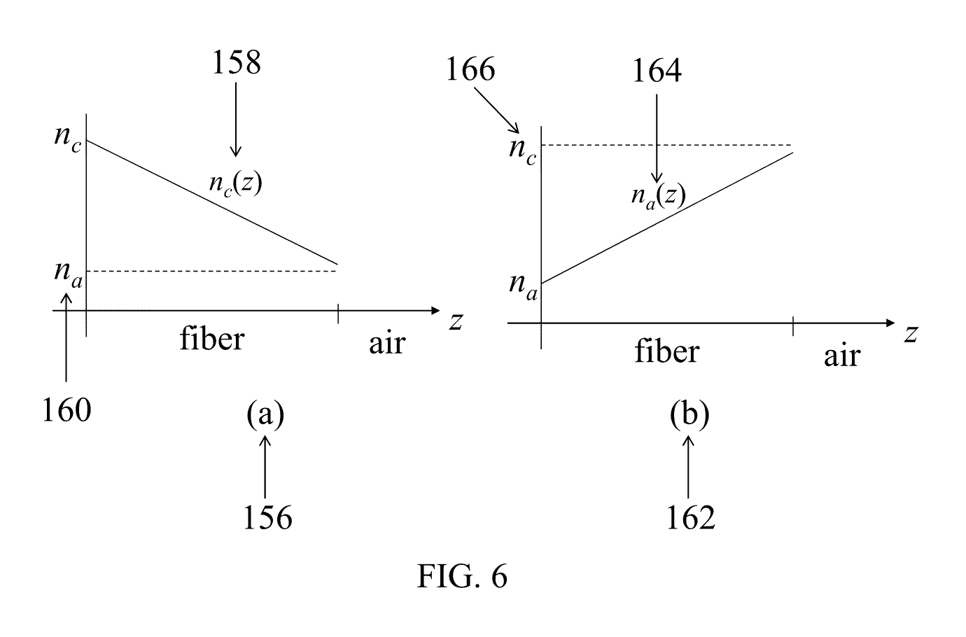

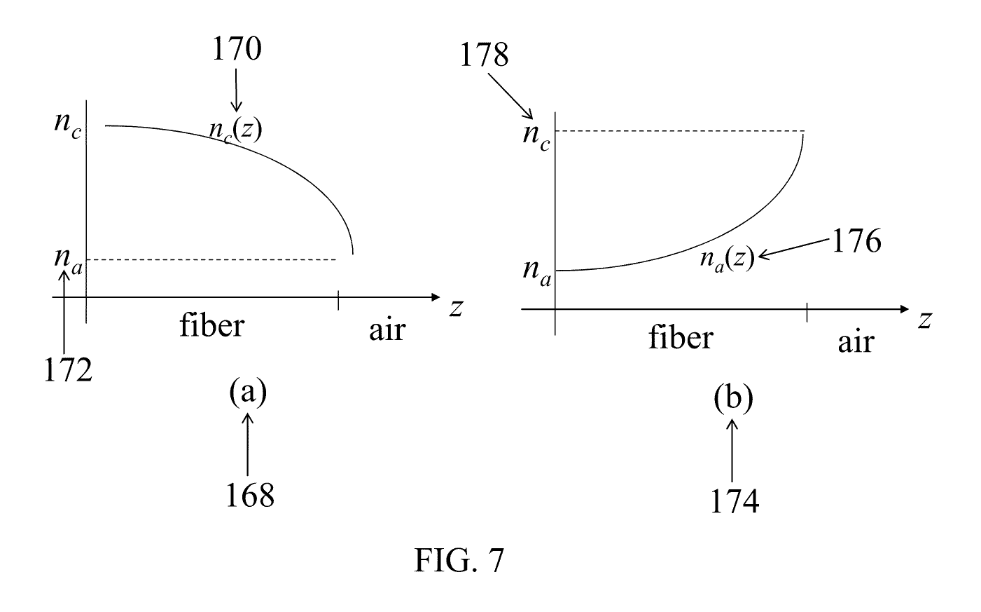

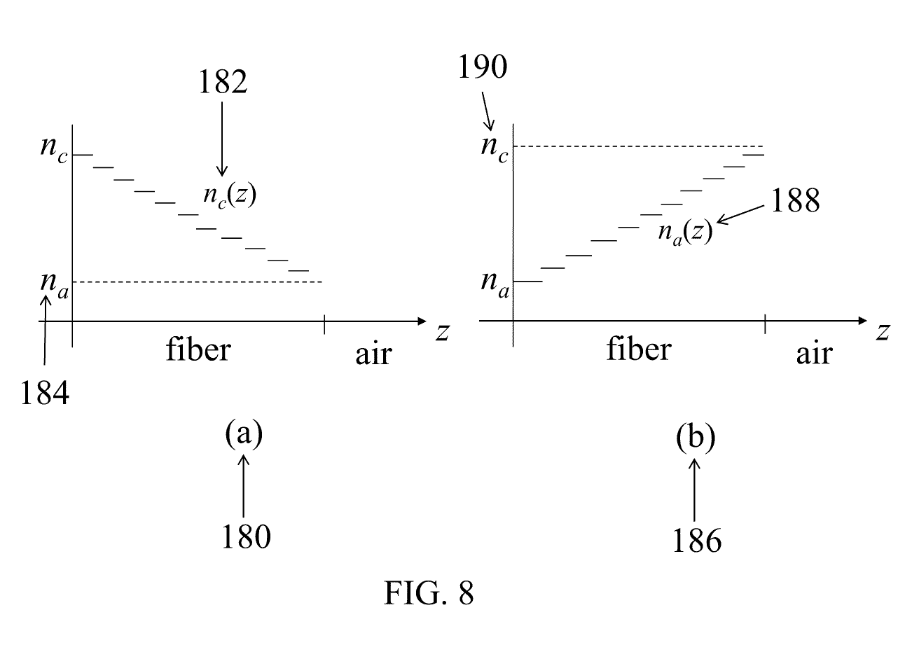

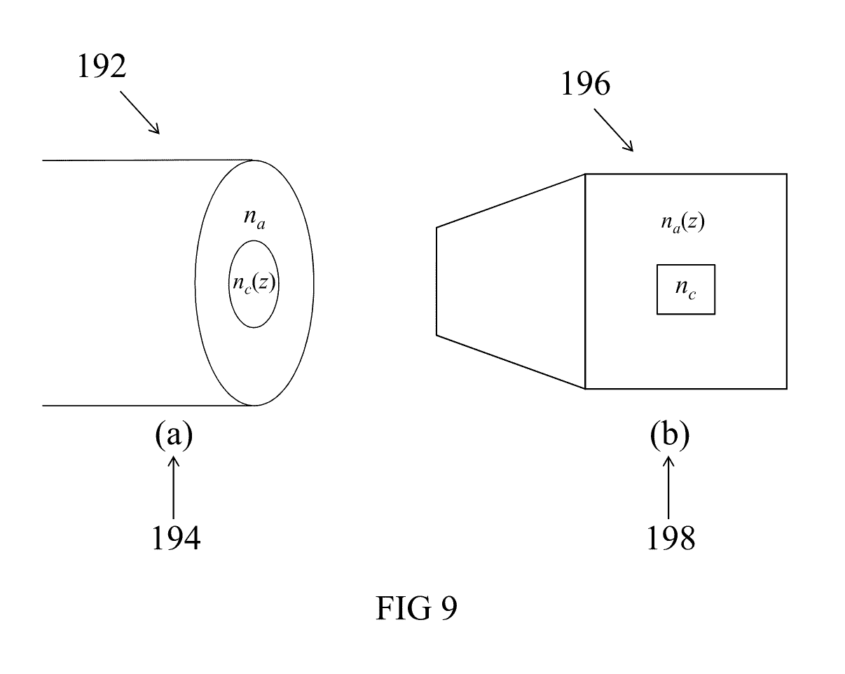

A number of embodiments of the invention have been described. Nevertheless, it should be understood that various modifications may be made without departing from the spirit and scope of the invention. The behavior of n_{c}(z)->nₐ or nₐ(z)->n_{c} or n_{c}(z),nₐ(z)->n_{b}, is defined as longitudinal graded-index of refraction in the present invention. In some examples, the way of one refractive index approaching the other can be a continuously linear function as shown in FIG. 6 (a) 156 for nₐ(z) 158->nₐ 160, (b) 162 for nₐ(z) 164->n_{c} 166, or a nonlinear function as shown in FIG. 7 (a) 168 for nₐ(z) 170->nₐ 172, (b) 174 for nₐ(z) 176->n_{c} 178, or discontinuously like a step function as shown in FIG. 8 (a) 180 for nₐ(z) 182->nₐ 184, (b) 186 for nₐ(z) 188->Ti_{c} 190. In some examples, the geometric structure of an optical structure can be circular 100 as illustrated in FIG. 1 or elliptical 192 as shown in FIG. 9 (a) 194 or a rectangular waveguide 196 as shown in FIG. 9 (b) 198. The cladding region of the above wave guided devices can be multi-layered or photonic crystal structure.

What is claimed is:

1. A beam collimator comprising:
a tapered-core guided wave structure with change of index of refractions longitudinally along the axial direction of the tapered-core guided wave structure.

2. The beam collimator of claim 1, wherein the tapered-core guided wave structure comprises:
an optical fiber.

3. The beam collimator of claim 1, wherein the tapered-core guided wave structure comprises:
an optical fiber with layered structure in the cladding.

4. The beam collimator of claim 1, wherein the tapered-core guided wave structure comprises:
an optical fiber with transverse graded index structure in the cladding.

5. The beam collimator of claim 1, wherein the tapered-core guided wave structure comprises:
a photonic crystal fiber.

6. The beam collimator of claim 1, wherein the tapered-core guided wave structure comprises:
a square waveguide.

7. The beam collimator of claim 1, wherein the tapered-core guided wave structure comprises:
a rectangular waveguide.

8. The beam collimator of claim 1, wherein the tapered-core guided wave structure comprises:
a cylindrical waveguide.

9. The beam collimator of claim 1, wherein the tapered-core guided wave structure comprises:
a waveguide with multi-layered structure in the cladding.

10. The beam collimator of claim 1, wherein the tapered-core guided wave structure comprises:
a waveguide with transverse graded index structure in the cladding

11. The beam collimator of claim 1, wherein the tapered-core guided wave structure comprises:
a photonic crystal waveguide.

12. A method comprising:
emitting a collimated beam from a tapered-core guided wave structure by gradually changing the index of refraction longitudinally in a core or a cladding region along the axial direction of the guided wave structure.

13. The changing of the index of refraction longitudinally of claim 12 comprising:
changing of the longitudinal index of refraction continuously.

14. The changing of the index of refraction longitudinally of claim 12 comprising:
changing of the longitudinal index of refraction discontinuously.

15. The changing of the index of refraction longitudinally of claim 12 comprising:
changing of the longitudinal index of refraction linearly.

16. The changing of the index of refraction longitudinally of claim 12 comprising
changing of the longitudinal index of refraction nonlinearly.

17. The changing of the index of refraction longitudinally of claim 12 comprising:
changing the index of refraction of the core to approach the index of refraction of the cladding.

18. The changing of the index of refraction longitudinally of claim 12 comprising:
changing the index of refraction of the cladding to approach the index of refraction of the core.

19. The changing of the index of refraction longitudinally of claim 12 comprising:
changing the indexes of refraction of the core and cladding to approach a value of index of refraction in between the value of index of refraction of the core and the value of index of refraction of the cladding.

20. A collimated beam generator comprising:
a beam collimator of a tapered-cored guided wave structure with change of index of refractions longitudinally along the axial direction of the tapered-cored guided wave structure;
an illuminating light source;
a light coupler positioned between the illuminating light source and the beam collimator.

21. The collimated beam generator of claim 20, wherein the illuminating light source comprises:
a coherent light source.

22. The collimated beam generator of claim 20, wherein the illuminating light source comprises:
an incoherent light source.

23. The collimated beam generator of claim 20, wherein the light coupler comprises:
a lens set.

24. The collimated beam generator of claim 20, wherein the light coupler comprises:
a gratings set.

25. The collimated beam generator of claim 20, wherein the light coupler comprises:
a holograms set.
